(19) United States
(12) Patent Application Publication
(10) Pub. No.: US 2003/0096135 A1
(43) Pub. Date: May 22, 2003

(54) Composite jewelry metal

(75) Inventors: Paul J. Dion, Norton, MA (US); Richard V. Carrano, Attleboro, MA (US)

Correspondence Address: WIGGIN & DANA LLP, ATTENTION: PATENT DOCKETING, ONE CENTURY TOWER, P.O. BOX 1832, NEW HAVEN, CT, 06508-1832, US

(73) Assignee: Stern Leach Company, a corporation of the State of Delaware

(21) Appl. No.: 10/299,869

(22) Filed: Nov. 19, 2002

Related U.S. Application Data
(60) Provisional application No. 60/331,813, filed on Nov. 20, 2001.

(51) Int. Cl. B32B 15/01

(52) U.S. Cl. 428/670; 428/672; 428/673

(57) ABSTRACT

A composite material that is usefull in the manufacture of jewelry components has a precious metal layer laminated to an age hardenable non-precious metal-base alloy support layer. In one embodiment, the precious metal layer is a 10 k, or higher, gold alloy and the support layer is a copper-base spinodal alloy. The composite material is formed by laminating the precious metal layer to the support layer, forming the composite material into a desired shape and then age hardening the jewelry component.

### CROSS-REFERENCE TO RELATED PATENT APPLICATION

This patent application relates to and claims priority to U.S. Provisional Patent Application Serial No. 60/331,813, entitled “Composite Jewelry Metal” by Dion et al. that was filed on Nov. 20, 2001. The 60/331,813 patent application is incorporated by reference in its entirety herein.

### BACKGROUND OF THE INVENTION

(1) Field of the Invention

This invention relates to laminates having a precious metal layer and a non-precious metal layer useful in the manufacture of jewelry. More particularly, a layer of gold or a gold alloy is laminated to a heat treatable copper-base alloy. In a preferred aspect of the invention, the heat treatable copper alloy has a spinodal microstructure.

(2) Description of the Related Art

As used through-out this patent application, the word “base,” as in copper-base alloy means that the alloy contains at least 50%, by weight, of the appended metal in this case copper. All compositions are in weight percent, unless otherwise specified and all mechanical properties were measured at room temperature, nominally 20° C. “Karat” is a unit of fineness for gold equal to 1/24 part by weight of pure gold such that 10 karat gold is 10/24=41.7% gold with the balance being a less precious metal such as copper, nickel, silver or zinc and mixtures thereof.

A variety of laminates have been used in the jewelry industry. One method to manufacture a laminate is known as the “Old Sheffield” process. A layer of a gold alloy or a silver alloy is mechanically bonded to a supporting metal such as nickel, brass (copper-zinc) or bronze (copper-tin). When the precious metal layer is a gold alloy, a silver alloy may form the supporting layer. Industry standards for gold laminates have developed over time. The term “Rolled Gold Plate” (RGP) broadly identifies a precious metal layer formed from ten karat (10 k), or higher, gold mechanically alloyed to a supporting layer. The term “Gold Filled” (GF) identifies a laminate where the gold alloy layer forms at least 5%, by weight, of the combined precious metal layer and supporting metal layer. Rolled Gold Plate and Gold Filled are distinguished from electroplating wherein a thin layer of gold is electrodeposited to a base metal usually after an article is fabricated from the base metal.

In one traditional method of manufacturing precious metal laminate sheet, precursor layers of the precious metal and base metal are placed together and held under high pressure for an appropriate time and under appropriate heating conditions so as to interdiffuse and form a boundary alloy fusing the two layers into a single composite. The resulting composite may be repeatedly fed through rolling mills under high pressure to reduce the piece to a desired sheet thickness while the ratio(s) of layer thicknesses remains substantially constant. The resulting sheet stock may then be formed into the desired jewelry or other articles. Similar results may be achieved via a continuous roll bonding process in which the precious metal and base metal layers originate in coils. As the layers are uncoiled, they are contacted with each other under pressure and, optionally, heat in the roll bonding process.

Wire may similarly be made by inserting a core rod of the base metal into a precious metal cylinder or tube and then fusing the two with an appropriate combination of pressure, heat, and time. The resulting rod may be repeatedly drawn through wire reducing mills to reduce it to a net or near net diameter. A finishing step may include drawing the near net wire through cut diamond dies to reduce the wire to the desired final diameter. The wire may be formed into non-round cross-sections via a number of techniques, including additional steps of feeding the wire through hardened steel shaping and patterned rolls.

In one method of manufacturing tubing, a flat disc of sheet material is subjected to a cup and draw process to produce tubing of desired diameter and wall thickness.

Various modifications of these basic methods are known. In certain applications the precious metal and base metal layers are initially solder-bonded in distinction to direct hot roll bonding. A sheet of the solder material may initially be placed in a sandwich of the precious metal and base metal layers. The sandwich may be heated under pressure to solder the precious metal and base metal layers to each other. In another modification, the total base metal may itself be formed by integrating a number of layers. For example, the precious metal may be initially bonded to a base metal layer having a thickness of about the same order of magnitude. The combination may then be bonded to a much thicker base metal layer.

In the jewelry industry, it has often been difficult to manufacture certain parts requiring relatively high strength and resiliency in thin and often convoluted form. Common brasses, bronzes, nickel silvers, and pure nickel used as support layers in GF material often are inadequate for such uses, leaving the jeweler with the undesirable prospect of having to use another material (e.g., steel) instead of the desired GF material. Although copper-beryllium alloys had, in the past, been used as a heat treatable base material, toxicity concerns regarding beryllium have placed such material in disfavor.

Separately, in the early 1970's, families of copper-nickel-tin alloys were developed as substitutes for copper-beryllium and phosphor-bronze alloys then in prevalent use in the manufacture of electrical wire, springs, connectors, and relay elements. Certain of these alloys are disclosed in U.S. Pat. Nos. 3,937,638, 4,052,204, and 4,090,890, the disclosures of which patents are incorporated by reference in their entireties herein as if set forth at length. The Copper Development Association (CDA), New York, N.Y., has assigned copper alloy numbers and issued specifications for certain such alloys.

### BRIEF SUMMARY OF THE INVENTION

In accordance with a first aspect of the invention, a composite material that is useful in the manufacture of jewelry components has a precious metal layer laminated to an age hardenable non-precious metal-base alloy support layer. In a preferred embodiment of this first aspect, the precious metal layer is a 10 k, or higher, gold alloy and the support layer is a copper-base spinodal alloy.

In accordance with a second aspect of the invention, the composite material is formed by laminating the precious metal layer to the support layer, forming the composite material into a desired shape and then age hardening the jewelry component.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 illustrates in cross-sectional representation a composite material useful in the manufacture of jewelry in accordance with a first embodiment of the invention.

FIG. 2 illustrates in cross-sectional representation a composite material useful in the manufacture of jewelry in accordance with a second embodiment of the invention.

FIG. 3 illustrates in cross-sectional representation a composite material useful in the manufacture of jewelry in accordance with a third embodiment of the invention.

FIG. 4 illustrates in cross-sectional representation a composite material useful in the manufacture of jewelry in accordance with a fourth embodiment of the invention.

FIG. 5 shows in flow chart representation a process to manufacture the composite materials of the invention.

FIG. 6 illustrates an earring having components formed from the composite material of the invention.

FIGS. 7A-7D illustrates in cross-sectional representation a first process for the manufacture of wire utilizing the composite material of the invention.

FIGS. 8A-8C illustrates in cross-sectional representation a second process for the manufacture of wire utilizing the composite material of the invention.

Like reference numbers and designations in the various drawings indicate like elements.

### DETAILED DESCRIPTION

FIG. 1 shows in cross sectional representation a composite material 10 having utility as a stock for the formation of jewelry. The composite material 10 has a precious metal layer 12 permanently bonded to a support layer 14. Preferably, the permanent bond is due to interdiffusion of atoms between the two layers as is achieved during a roll bonding procedure.

Precious metal layer 12 is any suitable precious metal or metal alloy containing a sufficient amount of precious metal to have applicability in the jewelry business. Gold and gold alloys of 10 k or higher may constitute the precious metal layer. Silver and silver alloys having in excess of 80% silver, and preferably at least 92.5% silver, as well as platinum and platinum alloys having in excess of 50% platinum may also constitute the precious metal layer.

The support layer 14 is an age hardenable non-precious metal-base alloy. When certain elements are alloyed with a base metal, a single phase solution is formed at elevated temperatures. By rapidly cooling the alloy, such as by quenching, a substantially single phase microstructure is retained. By then heating to a temperature below the solidus temperature for a specific composition, submicroscopic particles precipitate throughout the crystalline grains of the alloy, which results in a marked increase in strength and hardness. Alloys capable of a marked increase in strength and hardness by heating to a temperature below the solidus are age hardenable.

Preferably, the support layer 14 is copper-base and more preferably is a spinodal copper alloy containing nickel and tin. The copper base alloys consist essentially of between 3% and 30% nickel, 2% and 10% tin, and the balance is copper and inevitable impurities. Most preferably, the nickel content is between 6% and 10% and tin content is between 3% and 7%. Other alloying elements may be present that do not affect the age hardening response or otherwise detract from the utility of the alloy as a support layer for a jewelry composite. Preferably the alloy is substantially free of elements deemed hazardous, such as beryllium.

An exemplary alloy is designated by the CDA as C72650 and has a nominal composition, by weight, of 7.0% -8.0% nickel, 4.5% -5.5% tin, maximums of 0.01% lead, 0.10% iron, 0.10% zinc, 0.10% manganese and the balance is copper and unavoidable impurities, with the caveat that the unavoidable impurities do not exceed 0.3%.

The specific gravity of copper alloy C72650 is 8.87. Specific Gravity is the ratio of the density of a substance to the density of water at 4.0° C. which has a density of 1.00 kg/liter.

The alloy has a low annealing temperature. Annealability is important. The working of composite material during rolling or drawing to reduce cross-sectional area will work harden the material to a high level of strength and hardness. Without an anneal, rolling, drawing or formation into a jewelry product will be difficult. Annealing softens the material to permit further work. If the annealing temperature is too high, unwanted excessive diffusion of the support layer into the precious metal layer may occur causing the precious metal layer to be somewhat diluted and less noble. The result would be a loss in tarnish resistance and discoloration.

With the spinodal copper-base alloys, annealing is preferably at a temperature of below 677° C. (1250° F.) and, more preferably, in the range of 538° C.-593° C. (1000° F.-1100° F.) for a time effective to soften the composite to enable jewelry fabrication. An exemplary anneal period of one hour exposure to the annealing temperature is effective to reduce the hardness of the support layer from a value of approximately 250 DPH or more to a value of approximately 120 DPH. “DPH” refers to Diamond Pyramid Hardness, a number related to an applied load and the surface area of a permanent impression made by a square faced pyramidal diamond inserter having included angle faces of 136°

DPH=1.8544P/d²

Where P=applied load (kgf) and d is mean diagonal of the impression (mm).

Similarly, age-hardenability is an advantageous property as, once the composite material has been formed into the shape of the jewelry product it may be advantageous to age-harden the product to achieve a desired level of strength and/or maintain a spring temper. A proper spring temper is needed for elements such as certain clasps, springs and earring backs which, in service, are subjected to a continuous flexing strain. The composite material is heated to a desired temperature for a time effective to achieve sufficient precipitation to increase strength and hardness to desired values. Advantageously, the aging temperature is such that heat treatment for one hour at a temperature of less than 677° C. is effective to harden the base metal from an initial hardness of less than 150 DPH to a resulting hardness of at least 275 DPH. For the spinodal copper-base alloys used in the invention, age hardening is, more preferably, at a temperature of between 300° C. and 500° C. (572° F.-932°) for a time of between 0.5 hours and 4 hours. An exemplary aging heat treatment at 400° C. (750° F.) for one hour raises the hardness of copper alloy C72650 from approximately 120 DPH to approximately 350 DPH. The annealing and age-hardening may occur at various stages in the process for making a piece of jewelry. For example, soldering may soften the material and necessitate further heat treatment.

C72650 is a spinodal alloy and other similar spinodal alloys may likewise be utilized. A spinodal alloy structure is characterized by a fine homogeneous mixture of two phases that form by the growth of composition waves in a solid solution during suitable heat treatment. Phases of this spinodal structure differ in composition from each other and from the parent phase but have the same crystal structure as the parent phase. A copper-nickel-tin spinodal alloy falls within a single phase (α) region of the equilibrium phase diagram for copper, nickel, and tin at temperatures near the melting point of the alloy. The alloy falls within a two-phase (α+β) at room temperature.

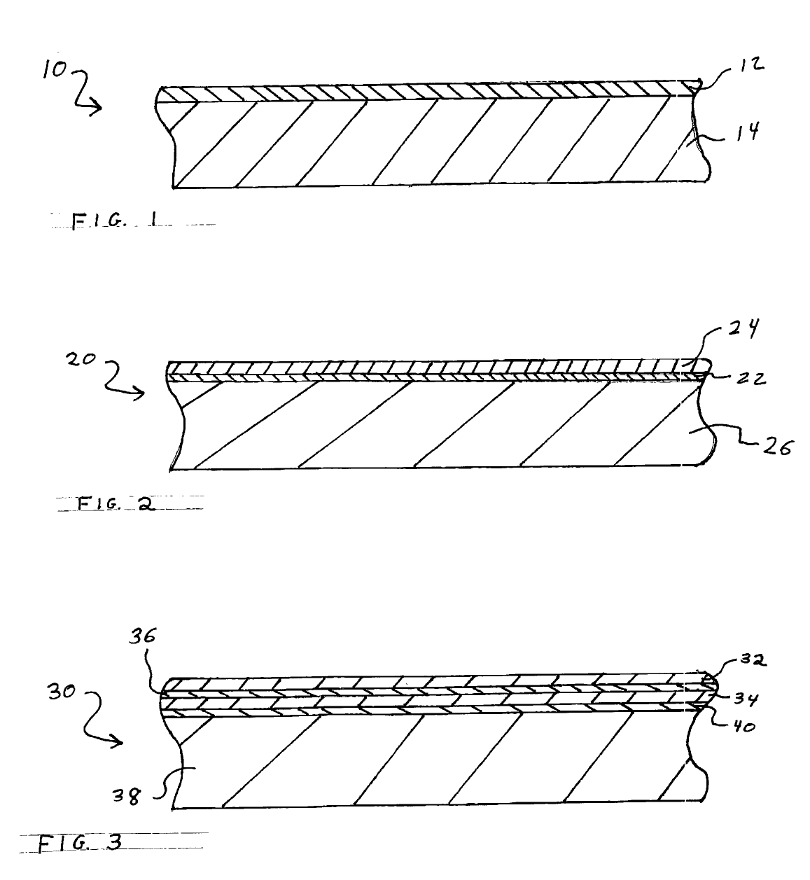

FIG. 2 illustrates in cross-sectional representation a composite material 20 useful for the manufacture of jewelry in accordance with a second embodiment of the invention. A first solder layer 22 is disposed between precious metal layer 24 and support layer 26. The first solder layer 22 is selected to be a solder that bonds to both the precious metal layer 24 and support layer 26 at relatively low temperature, typically the soldering temperature is less than 870° C. and preferably, the soldering temperature is between 535° C. and 810° C. For the preferred composite of a gold alloy precious metal layer and an age hardenable copper alloy support layer, preferred first solders include silver brazing alloys having a minimum silver content of 30%, by weight.

In accordance with a third embodiment of the invention, as illustrated in cross-sectional representation in FIG. 3, the composite material 30 useful for the manufacture of jewelry has precious metal layer 32 bonded to intervening support layer 34, such as by first solder layer 36. The joined intervening support layer and precious metal layer is then bonded to support layer 38, such as by second solder layer 40. Diffusion bonding, such as achieved during rolling may replace either the first or second solder layer, or both. FIG. 3 shows precious metal laser 32 of similar thickness as intervening support layer 34, while preferred, the precious metal layer and intervening support layer need not be of similar thicknesses.

As illustrated in cross-sectional representation in FIG. 4, any of the composite materials described herein above may also be manufactured with a first precious metal layer 50 bonded to a first side 52 of support layer 54 and a second precious metal layer 56 bonded to an opposing second side 58 of the support layer 54.

In accordance with another embodiment of the invention, the precious metal layer may be bonded to only a portion of the support layer, such as a stripe or inlay.

FIG. 5 illustrates in flow chart representation a series of process steps for the manufacture of the composite materials useful for the manufacture jewelry described hereinabove. The precious metal layer is bonded 60 to the support layer. In accordance with the embodiment of FIG. 1, a strip of support layer is placed against a strip of precious metal and the combination passed through a rolling mill for a thickness reduction of at least 35% in thickness. Preferably, this thickness reduction is between 35% and 97%, in thickness. The reduction in thickness disrupts the surfaces of the two layers leading to interdiffusion by a process referred to as cladding. The relative thicknesses of the precious metal layer and the support layer are selected so that the ratio of the thicknesses of precious metal to support layer is between approximately 0.001:1 to 0.5:1 in the finished composite. While the thicknesses of two layers are reduced while passing through the rolling mill, the relative ratios remain about the same. Typically, pre-bonding the thickness of the support layer is about 0.25 inch and the precious metal layer is about 0.05 inch. The finished composite preferably has an overall thickness of between 0.01 inch and 0.25 inch. The thickness reduction may be at room temperature, or at an elevated temperature of up to about 825° C. to facilitate thickness reduction and interdiffusion.

If the composite material is to be the embodiment illustrated in FIG. 4, a second precious metal layer is placed proximate to an opposing side of the support layer and diffusion bonded, typically at the same time as the first precious metal layer.

For the embodiment illustrated in FIG. 2, bonding is achieved by disposing a layer of solder or braze between the precious metal layer and the support layer and heating to a temperature effective to bond the precious metal layer to the support layer, such as between 535° C. and 810° C. After soldering or brazing, the composite assembly is reduced in thickness, such as by passing through a rolling mill as described above.

For the embodiment illustrated in FIG. 3, the precious metal layer is first soldered to the intervening support layer, such as by disposing a first solder layer between the precious metal layer and intervening support layer and heating to a temperature effective to melt first solder layer and join the layers together. A second solder layer is then disposed between the un-bonded side of the intervening support layer and the support layer and heated to melt the second solder layer to bond the joined layers to the support layer. Preferably, the second solder layer melts at a lower temperature than the first solder layer. For the preferred composite of the invention with a gold alloy precious metal layer and age hardenable copper-base alloy support layer, the first solder layer may be a silver containing braze or solder (melting temperature about 760° C.) and the second solder layer may be a silver containing braze or solder (melting temperature about 620° C.).

Alternatively, the solder melting step is combined with the bonding step, through the use of elevated temperature rolling.

After bonding 60, the composite is annealed 62, such as by heating to a first temperature of less than 677° C. and preferably between 538° C. and 593° C. for a time effective to reduce the strength of the composite for further processing. Typically, the composite will be annealed 62 for a time of between 30 minutes and 4 hours, and preferably for a time of between 30 minutes and 1.5 hours. Annealing is preferably done in a non-oxidizing atmosphere when the support layer is exposed and a non-oxidizing atmosphere when the support layer is not exposed, as in the embodiment illustrated in FIG. 4

Following annealing, the composite may be further reduced in thickness, if desired, through optional passing through a rolling mill 64. The steps of annealing and rolling may be repeated multiple times if required to achieve a desired finished thickness for the composite.

Once at the desired thickness for jewelry manufacture, typically between 0.005 inch and 0.25 inch, the composite is formed 66 into a desired jewelry component, such as a earring backing or spring clasp. Forming may be by machine to stamp and bend the composite strip into the desired configuration, such as for lower cost jewelry or hand formed for higher cost jewelry.

Following forming, the jewelry is age hardened 68 to increase strength and hardness. Aging is at a temperature less than the annealing 62 temperature For the spinodal alloys of the invention, age hardening is typically at a temperature of less than 677° C., subject to the caveat of less than the annealing temperature, and preferably aging is at a temperature of between 300° C. and 500° C. for from 0.5 hours to 4 hours in a non-oxidizing atmosphere.

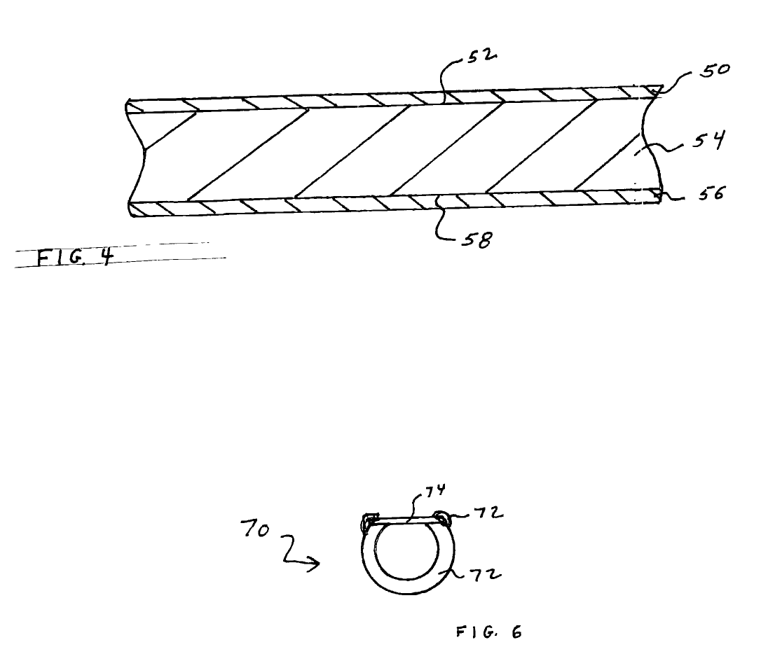

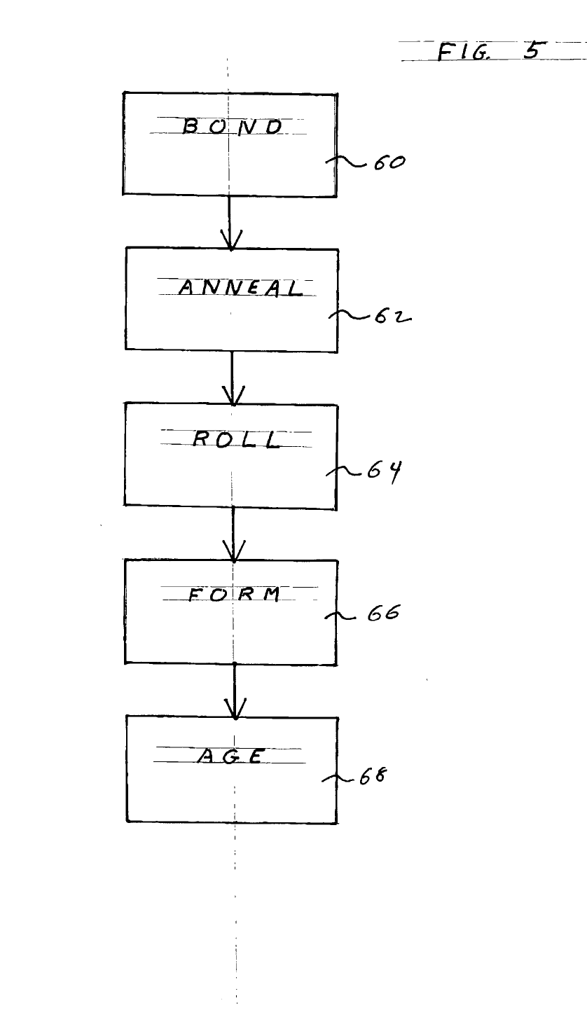

FIG. 6 illustrates an exemplary piece of jewelry with components manufactured from the composite material of the invention. Exemplary hoop earring 70 has a decorative hoof, 72 with a post 74 attached to the decorative hoop on one end by hinge 76. When the post is in place, such as extending through a pierced ear, an end of the post opposite the hinge is locked in place by clasp 78. The hinge, clasp and post are all subject to stresses and benefit from being manufactured from the high strength, high hardness composite of the invention.

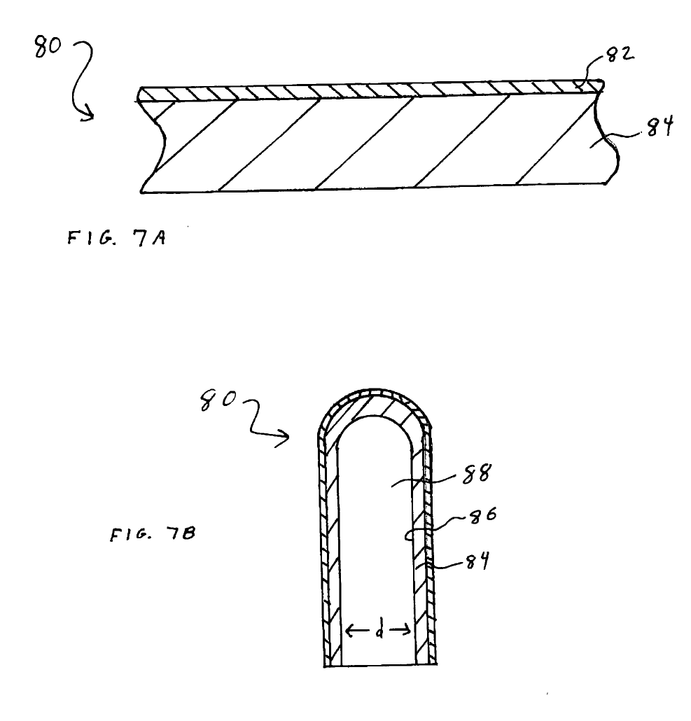

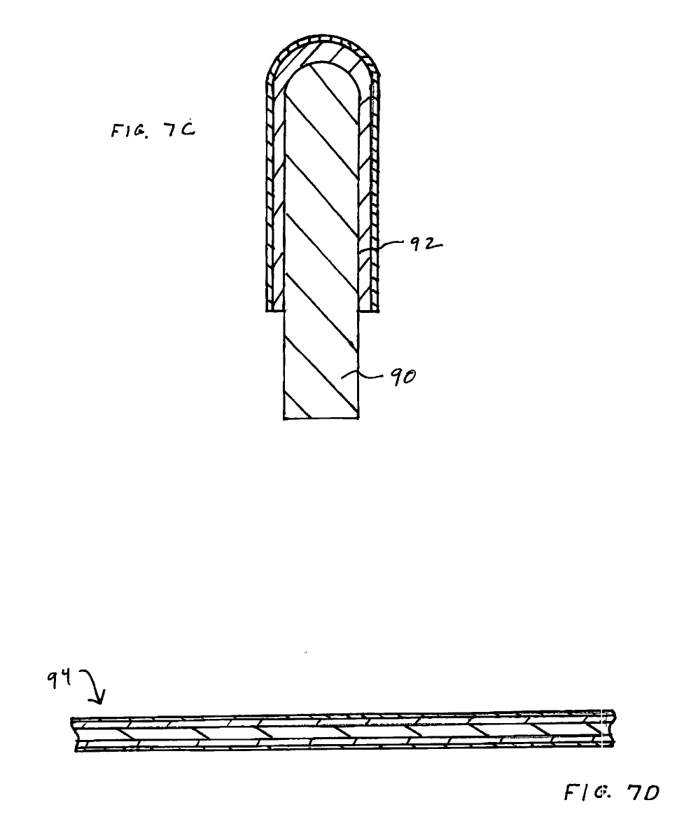

FIGS. 7A through 7D illustrate a method to manufacture wire from the composite material of the invention. Wire has particular utility in the manufacture of clasps and chains for jewelry. As shown in FIG. 7A, a composite material 80 is formed as described above. The composite material includes a precious metal layer 82 bonded to intervening support layer 84. The intervening support layer 84 may be any non-precious metal or metal alloy and need not be an age-hardenable metal alloy. In a preferred embodiment, the intervening support layer 84 is brass.

While not shown, there may be an solder layer between the precious metal layer and the support layer as described above. Likewise, an intervening support layer and second solder layer may form part of the composite material.

As shown in FIG. 7B, the composite material 80 is deformed into a tubular configuration such as by a cup and draw operation. The tubular configuration is formed so that the support layer 84 forms the sidewalls 86 of a centrally disposed bore 88 with a diameter “d”. As shown in FIG. 7C, a rod 90 of age-hardenable material is preferably coated with a solder or braze 92 such that the diameter of the rod and the solder coating is approximately equal to “d”. The solder coated rod is inserted into the centrally disposed bore 88 and heated to solder the rod to the intervening support layer 84. The soldered assembly is then reduced in thickness such as by drawing through wire-forming dies. Anneals, as described above, are used where needed to insure the assembly is sufficiently soft for continued wire drawing.

FIG. 7D shows the wire 94 when drawn to a desired diameter for manufacture of jewelry components. For example, the wire can be formed into chain links or clasps and then heat treated to age-harden.

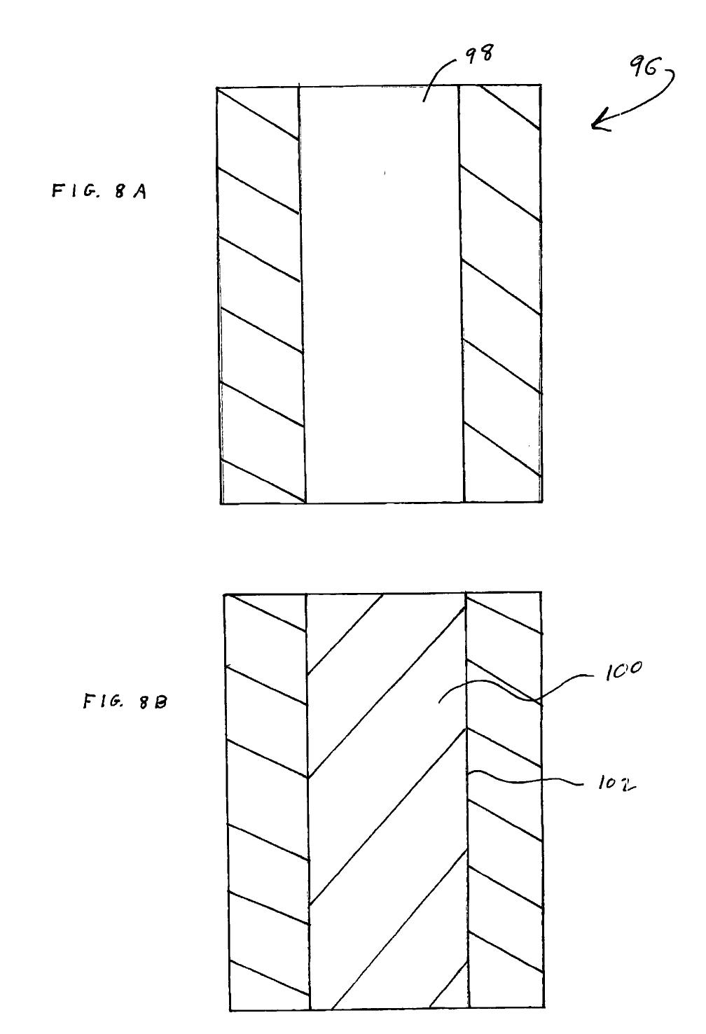

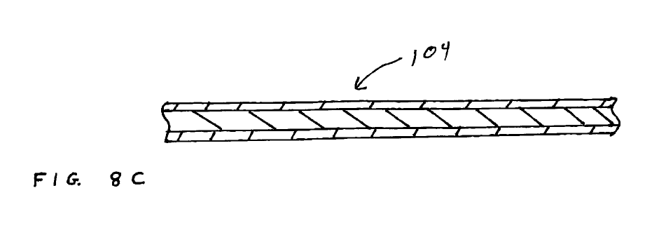

FIGS. 8A through 8C illustrate a second method to manufacture wire from the composite material of the invention. A precious metal rod 96 has a central bore 98 drilled therethrough to form a precious metal cylinder. A rod 100 that preferably is solder or braze 102 coated has a diameter about equal to the diameter of the central bore and is inserted into the central bore and heated to fuse the solder to the inside sidewalls of the precious metal cylinder 96. The assembly is then reduced in thickness such as by drawing through wire-forming dies. Anneals, as described above are used where needed to insure the assembly is sufficiently soft for continued wire drawing.

FIG. 8C shows the wire 104 when drawn to a desired diameter for manufacture of jewelry components. For example, the wire can be formed into chain lick or clasps and then heat treated to age-harden.

One or more embodiments of the present invention have been described. Nevertheless, it will be understood that various modifications may be made without departing from the spirit and scope of the invention. Accordingly, other embodiments are within the scope of the following claims.

What is claimed is:

1. A composite material having utility in the manufacture of jewelry components, comprising:
a precious metal layer; and
a support layer formed from an age-hardenable non-precious metal-base alloy laminated to a first side of said precious metal layer.

2. The composite material of claim 1 wherein said precious metal layer is selected from the group consisting of gold, silver, platinum, 10 k and higher gold alloys, silver-base alloys containing at least 80%, by weight, silver and platinum-base alloys containing at least 50%, by weight, platinum.

3. The composite material of claim 2 wherein said precious metal layer is a 10 k or higher gold alloy.

4. The composite material of claim 2 wherein said support layer is an age-hardenable copper-base alloy.

5. The composite material of claim 4 wherein said support layer is a spinodal copper-base alloy.

6. The composite material of claim 5 wherein said support layer is a copper-base alloy containing from 3% to 30%, by weight, nickel and 2% -10%, by weight, tin.

7. The composite material of claim 6 wherein said support layer is a copper-base alloy containing from 6% to 10%, by weight, nickel and 3% to 7%, by weight, tin.

8. The composite material of claim 7 wherein said support layer is a copper-base alloy containing 7% to 8%, by weight, nickel and 4.5% to 5.5%, by weight, tin.

9. The composite material of claim 3 wherein said support layer is a copper-base alloy containing 7% to 8%, by weight, nickel and 4.5% to 5.5%, by weight, tin.

10. The composite material of claim 4 wherein a first solder layer is disposed between said precious metal layer and said support layer.

11. The composite material of claim 4 wherein said first solder layer is selected to lie a silver containing braze or solder.

12. The composite material of claim 10 wherein an intervening support layer and a second solder layer are disposed between said first solder layer and said support layer.

13. The composite material of claim 12 wherein said second solder layer is selected to be a silver containing braze or solder with a melting temperature less than the first solder layer.

14. The composite material of claim 4 further including a second precious metal layer bonded to an opposing second side of said support layer.

15. The composite material of claim 10 wherein a second precious metal layer is bonded to an opposing second side of said support layer by a third solder layer.

16. The composite material of claim 12 wherein a second precious metal layer is bonded to an opposing second side of said support layer by a third solder layer with an intervening support layer and a fourth solder layer interposed between said third solder layer and said support layer.

17. A method for the manufacture of a composite material having utility as a jewelry component, comprising the steps of:
a). bonding a precious metal layer to a first side an age hardenable non-precious metal support layer thereby forming said composite material; and
b). age hardening said composite material.

18. The method of claim 17 wherein said precious metal layer is selected from the group consisting of a gold alloy of 10 k or higher, a silver-base alloy containing at least 80% by weight of silver and platinum-base alloys containing at least 50% by weight platinum and said non-precious metal support layer is selected to be a copper-base spinodal alloy.

19. The method of claim 18 wherein prior to age-hardening said composite material, said composite material is annealed and formed into a desired shape.

20. The method of claim 19 wherein an annealing temperature is higher than an age hardening temperature.

21. The method of claim 20 wherein said annealing temperature is from 538° C. to 593° C. and said age hardening temperature is from 300° C. to 500° C.

22. A method for the manufacture of wire having utility in the manufacture of jewelry components, comprising the steps of:
a). forming a composite of a precious metal layer bonded to an intervening support layer;
b). forming said composite into a tubular configuration with a centrally disposed bore of diameter “d”, said intervening support layer forming sidewalls of said centrally disposed bore;
c). bonding a rod of age-hardenable material into said centrally disposed bore;
d). reducing the diameter to said composite and rod assembly to a desired diameter for said wire;
e). forming said wire into a desired jewelry component; and
f). age hardening said desired jewelry component.

23. The method of claim 22 wherein said precious metal layer is selected from the group consisting of a gold alloy of 10 k or higher, a silver-base alloy containing at least 80% by weight of silver and platinum-base alloys containing at least 50% by weight platinum and said non-precious metal support layer is selected to be a copper-base spinodal alloy.

24. The method of claim 23 wherein prior to age-hardening said composite material, said composite material is annealed and formed into a desired shape.

25. The method of claim 24 wherein an annealing temperature is higher than an age hardening temperature.

26. The method of claim 25 wherein said annealing temperature is from 538° C. to 593° C. and said age hardening temperature is from 300° C. to 500° C.

27. A method for the manufacture of wire having utility in the manufacture of jewelry components, comprising the steps of:
a). forming a precious metal cylinder having a central bore of diameter “d”;
b). bonding a rod of age-hardenable material into said central bore forming a composite;
c). reducing the diameter to said composite to a desired diameter for said wire;
d) forming said wire into a desired jewelry component; and
e). age hardening said desired jewelry component.

28. The method of claim 27 wherein said precious metal layer is selected from the group consisting of a gold alloy of 10 k or higher, a silver-base alloy containing at least 80% by weight of silver and platinum-base alloys containing at least 50% by weight platinum and said non-precious metal support layer is selected to be a copper-base spinodal alloy.

29. The method of claim 28 wherein prior to age-hardening said composite material, said composite material is annealed and formed into a desired shape.

30. The method of claim 29 wherein an annealing temperature is higher than an age. hardening temperature.

31. The method of claim 30 wherein said annealing temperature is from 538° C. to 593° C. and said age hardening temperature is from 300° C. to 500° C.
